(19) United States
(12) Patent Application Publication
(10) Pub. No.: US 2013/0180670 A1
(43) Pub. Date: Jul. 18, 2013

(54) DRAPE AND METHOD OF MAKING SAME

(71) Applicant: Ren Judkins, Pittsburgh, PA (US)

(72) Inventor: Ren Judkins, Pittsburgh, PA (US)

(21) Appl. No.: 13/739,892

(22) Filed: Jan. 11, 2013

Related U.S. Application Data
(60) Provisional application No. 61/585,829, filed on Jan. 12, 2012.

(51) Int. Cl. A47H 23/00; B23P 11/00

(52) U.S. Cl. CPC A47H 23/00; B23P 11/00
USPC 160/84.04; 29/428

(57) ABSTRACT

A drape is made from a series of strips of material arranged side by side and attached together in a manner so that each pair of adjacent lengthwise sides of each strip when joined together form a tab. Each strip has a sharp lengthwise pleat substantially parallel to and between the sides of the strip such that the drape has a series of sharp folds projecting outward on the front of the drape and a series of tabs projecting outward from the back of the drape.

### CROSS REFERENCE TO RELATED APPLICATION

This application claims the benefit of U.S. Provisional Application No. 61/585,829 filed Jan. 12, 2012.

### FIELD OF INVENTION

The invention relates to draperies used to cover windows and other architectural openings.

### BACKGROUND OF THE INVENTION

Draperies are a well-known product used to cover a window or other opening. Drapes are typically made from a panel of fabric which is hung vertically from a rod or other carrier. The fabric may be woven or non-woven. Rings, snaps, or hooks may be used to attach the drapery material to the rod or to carriers on the rod. If carriers are used a cord may be provided for moving the carriers and attached drapery across the rod.

When the drapery is in an open position the drapery material is stacked at one or both ends of the rod. A rule of thumb in the industry is that for every foot of window to be covered there will be four inches of stacked material when the drapery is in a fully open position. Drapery and curtains are rarely hung inside the window frame because the stacks would cover so much of the window. Consequently, the drapery rod must extend across the wall adjacent the window so that the stack of drapery material will not cover the window when fully opened. If sufficient wall space is not available for the stack, then even in a fully open position the drapery will obscure a portion of the window reducing the amount of light that can enter the room and the view to the outside. It costs a significant amount of money for fabric, labor and hardware to cover the wall. The wall space covered by the drape cannot be used and furniture cannot be placed close to that wall space. Consequently, there is a need for a tighter stacking drapery.

Folding doors and room dividers are sometimes used to cover an architectural opening. These doors and room dividers may be hung on a track above the opening or in the ceiling. These products have a series of flat panels between the folds. Although these panels form a slightly tighter stack when the door is in an open position, these structures have generally not been used as window coverings. Because of the flat appearance of the panels they are quite different in appearance from the draperies which are used as window coverings. Consumers expect draperies to have a soft or curved appearance, not the hard, flat appearance of a folding door. Furthermore, folding doors and room dividers are typically made from materials that are not used in window coverings. Many consumers select window coverings that closely match carpeting or upholstery in color and/or style. Such a match cannot be made using the materials that are conventionally used for folding doors.

Draperies are available in a variety of materials, but woven, knitted or non-woven materials that have a soft hand and hold a crease are preferred. These materials have a more soft appearance and may naturally fold when the drapery is moved laterally to one side of the window when the drapery is opened. Draperies are usually made from a single sheet of material, or from a sheet made from sewing together loom width pieces of fabric, that is sized to cover half or all of a window. In some drapes lengthwise pleats or folds are ironed or sewn into the material. When the drape is hung these pleats face the window rather than the room because it is very difficult to pleat a drape so that all of the pleats are parallel to one another and stitched perfectly. Because of the difficulty in creating lengthwise pleats in a drape that are all parallel to one another and precise, there are few drapes, if any, with permanent pleats on the back and even fewer drapes which have sharp lengthwise pleats that face the room.

There is a need for a drape which can form a tight stack when in fully open position and has the soft fabric appearance of conventional drapes when in open position. A drape having an extremely small stack would make that drape comparable to other kinds of window coverings, such as vertical blinds which have small stacks and are often installed in the window casing. Smaller spaces in modern homes make it very desirable to have less of the space near the window taken up by the volume of a large drapery stack which usually extends 4 to 6″ into the room. There is also a need for a drape which can be made without sewing machines and roll goods inventory which many fabricators do not have.

A perspective view of a drapery system of the type currently known in the industry is shown in prior art FIG. 1. The drapery system 10 is comprised of a section of drapery fabric 12 having a series of vertical creases 13 provided thereon. Each of the vertical creases 13 point in the same direction (toward the wall or window being covered by the drapery). The drapery fabric has an upper end 20 which is connected to and supported by an overhead supporting rail 14. A pull cord 16 is attached to a master carrier (not shown) that runs through rail 14 and is used to selectively open and close the drapery.

A preferred means of supporting the drapery fabric and opening or closing the drapery system already known in the art is shown in FIGS. 1 and 2. The overhead supporting rail 14 has two channels 15 and 17 disposed through its length. The slide channel 15 opens along the bottom of the supporting rail 14 substantially along the entire length of the supporting rail 14. A number of carriers 22 are disposed within the rail channel 15 so as to be movably engaged with the rail 14. Each carrier 22 has a generally H-shaped cross section that allows the carrier to slidably fit within the slide channel 15. Being H-shaped, the carrier has a wide slide portion 23 which is disposed within the rail channel 15. A spacer cord 11 runs between adjacent carriers 22.

A series of supporting means, which are typically pendants 18, are connected to the upper end 20 of the drapery fabric 12 and are also connected to the carriers 22. The pendants 18 can be connected to a strip 19 of nylon strap which is attached to the drapery fabric 20 by any convenient means such as by being snapped on, fastened with Velcro™ type fasteners, welded or sewn thereto. Each pendant has a body portion 24 which is affixed to the drapery fabric 12 and also has a head portion 26. The pendant head portion 26 is relatively enlarged and connects to the pendant body portion 24 by means of a relatively narrow neck 27.

The carriers 22 each have a base 30 having a mouth thereupon. The carrier mouth 28 is sized and configured so as to receive the neck 27 of the pendant 18, typically through a snap fit. The pendant head portions 26 prevent the pendant head 26 from moving vertically relative to the carriers 22 when the pendant head 26 is snap fit into the carrier 22. Yet, the pendant is free to rotate about a vertical axis through the neck.

In this way, each of the carriers 22 is connected through the pendant 18 to the drapery fabric upper end 20. The pull cord 16 is connected to the master carrier (not shown) which is connected to at least one of the carriers 22 or which is a carrier itself. Thus, the pull cord is able to move the carriers and thus the drapery fabric 12 along the rail 14. When the pull cord is pulled in one direction the master carrier pushes the other carriers closer together and causing the drapery fabric to fold over itself and to be gathered at one end of the rail. The drapery system is then said to be in the open position. When the pull cord is pulled in the opposite direction, master carrier pulls all the carriers until they are spaced fully apart from one another. Now, the drapery system is said to be in the closed or drawn position.

In addition to pendants, other supporting means, such as a hook and eyelet arrangement, are also used. The system functions similarly with these other supporting means. For, example, a series of eyelets may be provided along the upper end of the drapery fabric. Then, a number of hooks are provided so that each hook may engage an eyelet and connect to the carrier. Or, a series of hooks can be provided along the upper end of the drapery fabric. Each hook then engages an eyelet upon a carrier. Preferably, the hook or eyelet can rotate about an axis through the hook or eyelet. It is also known to provide holes, or holes with grommets, through the top portion of a drape or curtain through which a support rod may pass. Some shower curtains are made this way.

Drapery materials are preferred that have a more soft appearance and may naturally fold over when the drapery is moved laterally to one side of the window when the drapery is opened. However, such readily foldable materials tend to sag at the plurality of supports along the upper end of the drapery. For this reason and for aesthetic purposes, i.e. to provide a more full appearance, draperies require stiffness along their upper end to prevent sagging at the supports.

Stiffness has been provided to the upper end of drapery fabric by permanently affixing sections of materials, such as by sewing, to the upper end of the drapery fabric. Most often a continuous strip of material is sewn to the top of the drape in conjunction with a hem that may or may not wrap around the strip. Another method is to attach permanent extra sections of relatively stiff material between adjacent drapery fabric creases along the upper end of the drapery fabric. The extra sections of material are collectively referred to as “the header” of the drape. In this way, the drapery fabric may still fold along its creases but will maintain an unfolded, bowed, “full” appearance between creases.

In my U.S. Pat. No. 5,765,2601 disclose a drapery with a removable header and in my U.S. Pat. No. 5,857,5111 disclose a drapery with heart-shaped headers. These headers are designed for drapes that are hung from carriers and are not particularly suited for drapes having holes, or holes with grommets, through the top portion of a drape. Consequently, there is a further need for a header that can be used for this type of drape.

### SUMMARY OF THE INVENTION

I provide a drape made from a series of strips of material arranged side by side and, attached together in a manner so that each pair of adjacent lengthwise sides of each strip when joined together form a tab. Each strip has a sharp lengthwise pleat substantially parallel to and between the sides of the strip such that the drape has a series of sharp folds projecting outward on the front of the drape and a series of tabs projecting outward from the back of the drape.

I further provide headers attached to the top edge of the drape, one header attached to each strip of material. The header has two sides, each side having a front edge and a rear edge, the sides being connected together along their front edges to form a joint, and a septum connected between the joint and the sharp lengthwise pleat in the strip of material. The header also has a spacer connected to and between the two sides. I prefer that the sides each be a strip of material folded to have a center section, a left section and a right section, the left section and the right section being folded over the center section to overlap one another. The left section is attached to the right section and the left section and right section together may be pulled away from the center section. Preferably each strip has a pair of aligned holes through which a drapery rod may pass, the holes being at the center of gravity of the strip. A grommet or portal may be provided within each hole in each strip and bonded to the strip.

### BRIEF DESCRIPTION OF THE FIGURES

FIG. 1 is a perspective view of a prior art drapery system.

FIG. 2 is a perspective view showing a prior art means for mounting and for opening and closing the drapery fabric.

FIG. 3 is a front view of my drape in a fully drawn position.

FIG. 4 is a perspective view showing an upper portion of the drape.

FIG. 5 is a perspective view of the upper portion of the drape shown in FIG. 3 with a partial grommet.

FIG. 6 is a front view illustrating how the drape would appear in a collapsed position.

FIG. 7 is a top perspective view of a portion of the drape shown in FIGS. 3 and 4.

FIG. 8 is a top view similar to FIG. 5 showing a portion of the drape partially collapsed.

FIG. 9 is a rear view of a portion of the top of the drape showing the header.

FIG. 10 is a perspective view of a strip of material used in the drapery.

FIG. 11 is a drawing of a stack of material from which the drape is made.

FIG. 12 is a top view of another header that can be used in the drape shown in FIGS. 3, 4, and 6.

FIG. 13 is a rear perspective view of the header shown in FIG. 12.

FIG. 14 is a top view of a side of the header shown in FIGS. 12 and 13 during construction of the side.

### DESCRIPTION OF THE PREFERRED EMBODIMENTS

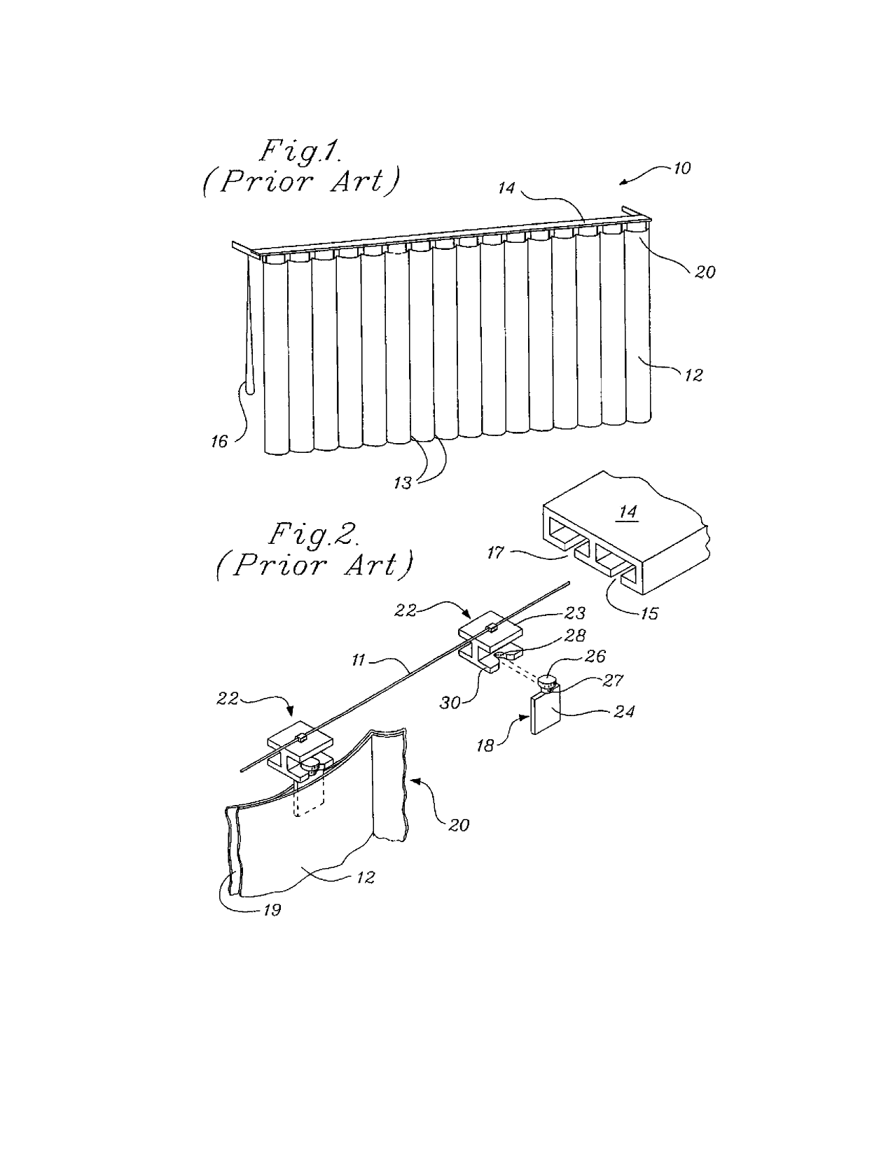

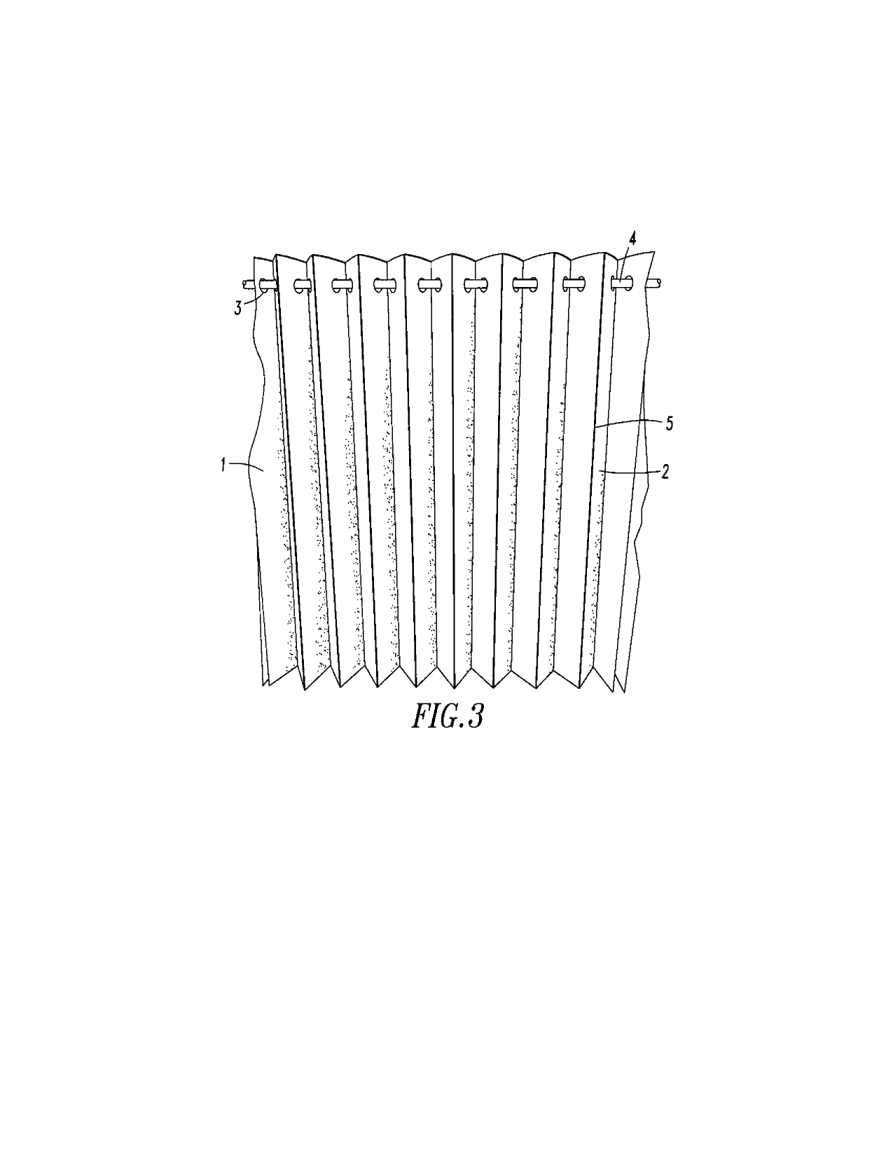

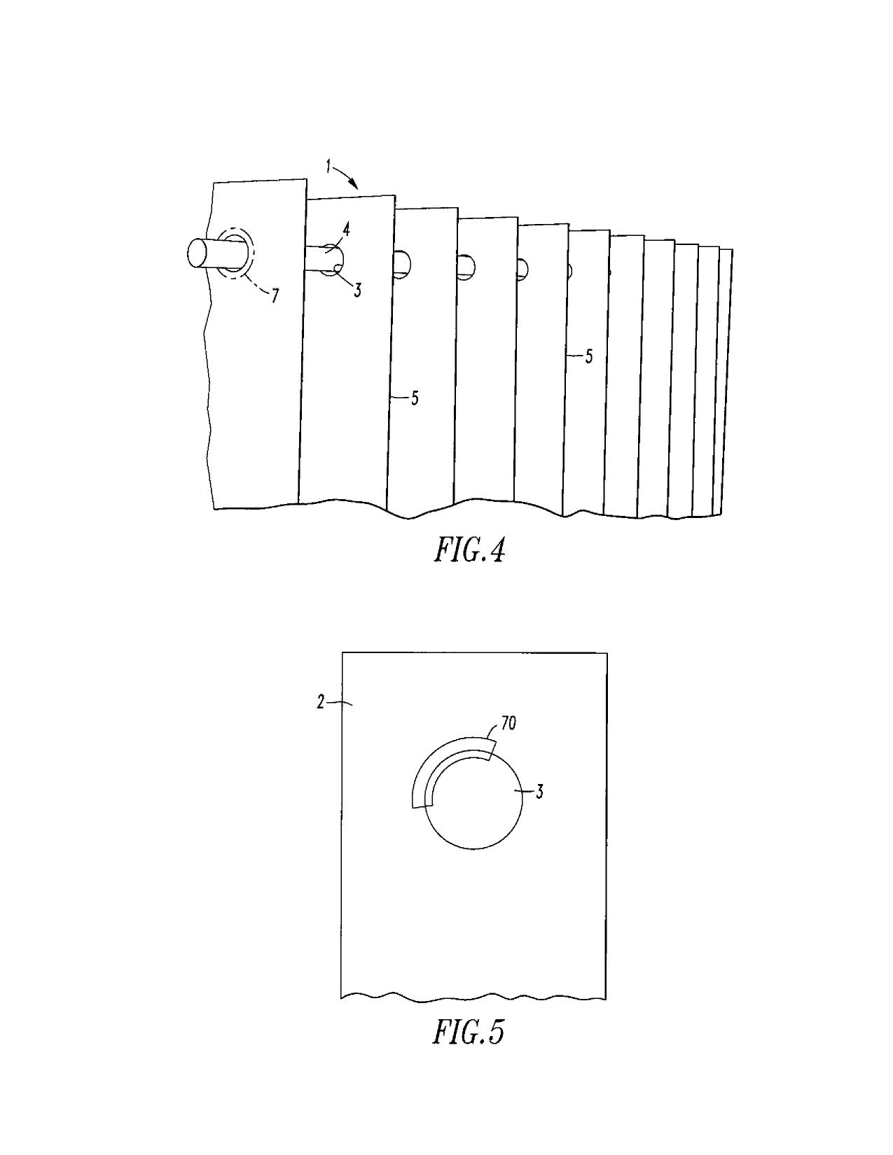

Referring to FIGS. 3 through 6, the drape 1 consists of a series of folded strips 2 which have been attached together to create a pleated panel. Holes 3 may be provided at the top of the drape so that the drape can be fitted onto a support rod 4. This can be seen most clearly in FIG. 4. Alternatively, the drape can be hung on carriers like those shown in FIG. 2 so holes are not necessary in all embodiments. Each strip has substantially parallel longitudinal edges and is folded to create a sharp pleat 5 that is parallel to the longitudinal sides. If desired the fabric from which the strips are made can be a fabric like polyester that can have a crease permanently heat set or a material that can be treated with stiffening material that will help maintain this pleat. The edges of the strips are bonded together to form a series of rearward facing tabs 6.

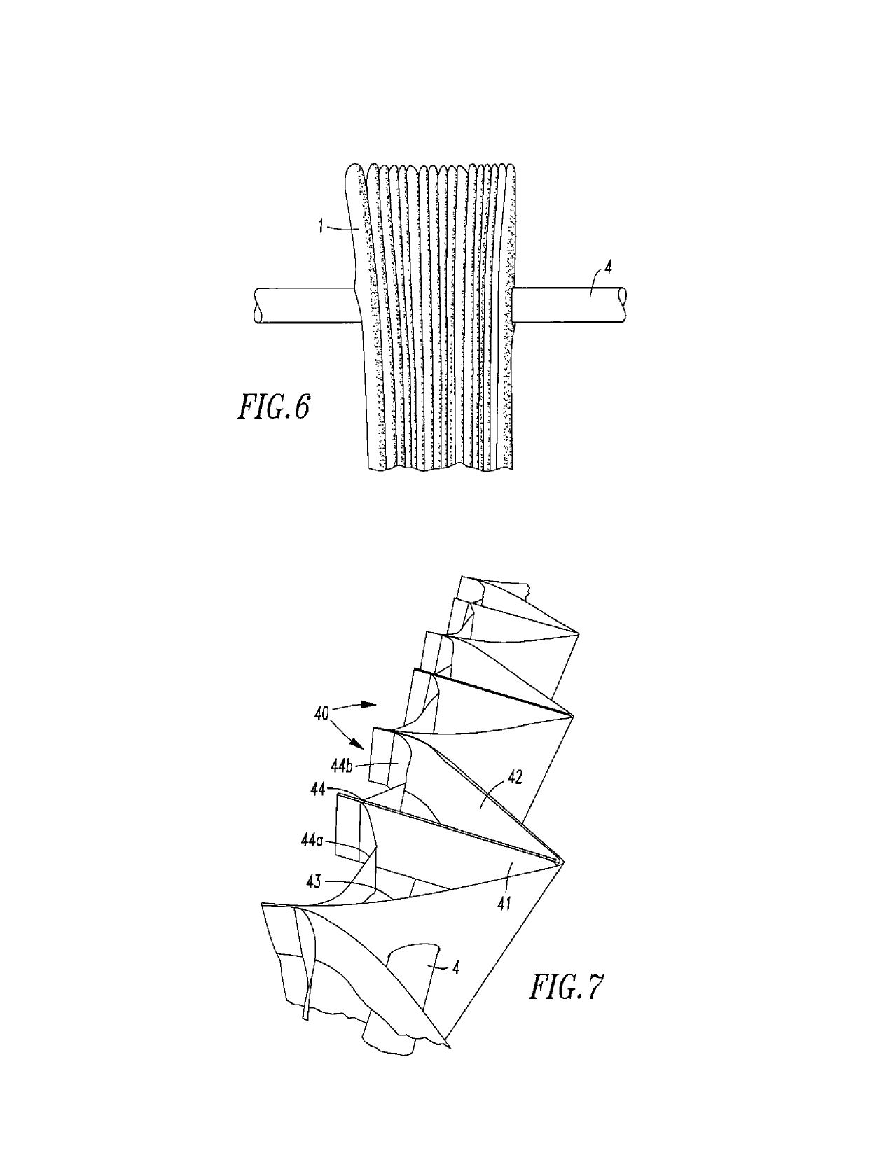

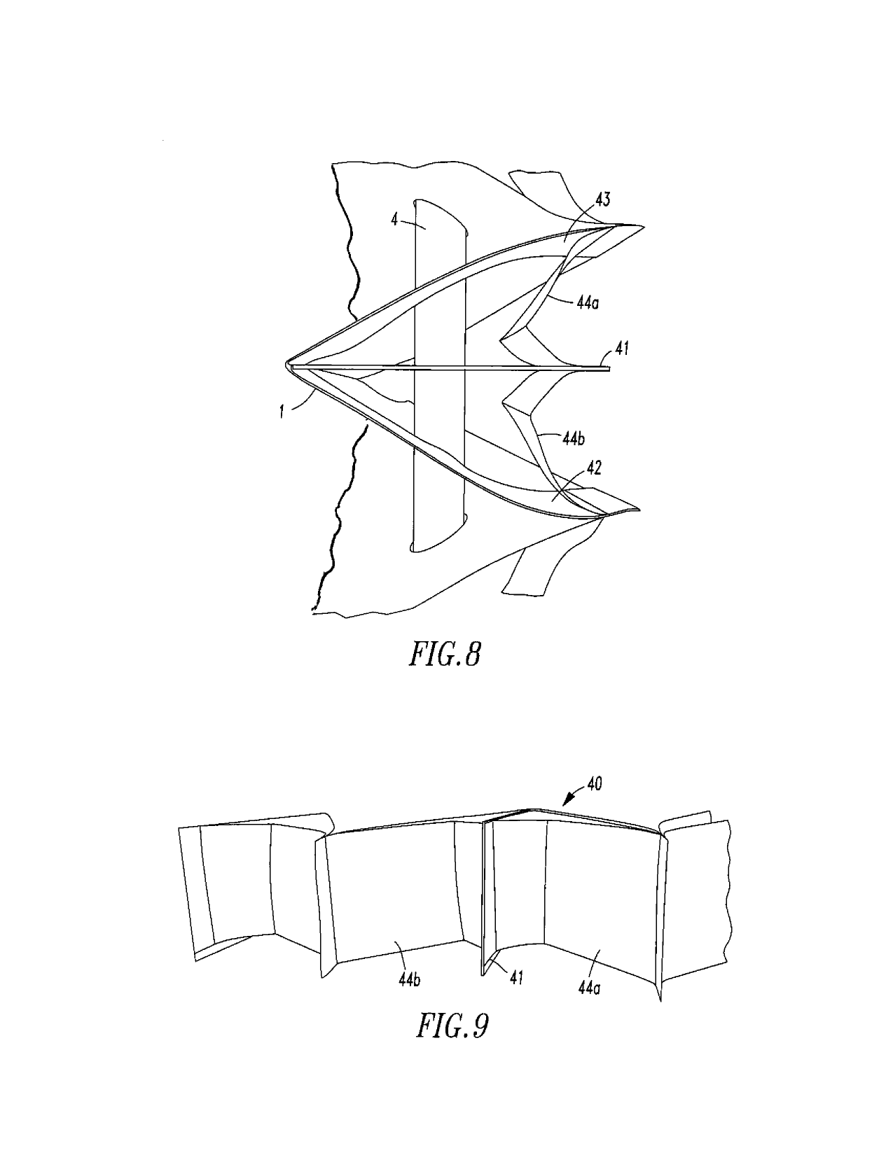

Referring to FIGS. 6 through 9 a header 40 is provided at the top of each panel. The header has a center rib 41, two sides 42, 43 and a spacer 44. The sides and spacer together form a generally triangular shape. The spacer has two segments 44a and 44b, each segment extending from the center rib 41 to the rear edge of one of the sides 42, 43. These segments each have a fold in the middle such that the header 40 can be collapsed from the open position shown in FIG. 7 to the closed position in which the drapery material is stacked tightly together shown in FIG. 6. When the drapery is fully extended along the rod as shown in FIG. 3, the sides 42, 43 of the header 40 are curved. This curvature conforms to the curvature the material in the panels giving the drapery curvature rather than a flat appearance as one sees in conventional pleated material or folded doors. The curvature is mostly a function of the permanent crease and particularly the tab. The tabs 6 on the back of the drapery 1 provide some stiffness and also contribute to the curvature of the panels. The sides, center rib 41 of the header can be sized so that the header rides on the center rib or the header may be above the support rod 4.

A significant advantage of this drapery is that the drapery can be made from a series of fabric segments which are attached together edge to edge. This construction imparts a slight curvature to the fabric that is complimented by the sharp creases. The curvature gives depth and character to the drapery. When the drapery is in a fully open position shown in FIG. 6 the stack is many time smaller than that of conventional drapes. A drape of the type shown in FIGS. 3 and 4 when made to cover a nine foot opening will collapse to a stack of about three inches in width.

For some drapery materials it may be preferable to provide grommets 7 around the holes 3 in the material as shown in FIG. 4. Because grommets may detract from the appearance of the drape 1 prefer to use partial grommets 70 shown in FIG. 5. These partial grommets extend from a nine o'clock position to a one o'clock, or perhaps from a ten o'clock position to slightly past a twelve o'clock position on the circumference of the hole. Unlike standard grommets that are press fit around the hole, the partial grommet 70 is preferably glued to the material. An adhesive bond distributes the load better than a snap fit. These partial grommets preferably have a larger surface area than the edge of the hole in the drape to distribute the load over a broader area. Indeed, I prefer to provide a large flange on the edge of the grommet that is hidden from the front side. A significant advantage of the partial grommet is that it provides the necessary support for the drape riding on the support rod while being obscured from view by the support rod. Because the partial grommet does not entirely encircle the hole, there is more room for the rod than would be available if a standard grommet were used.

The center rib can be lower than the holes in the drape so that the pole is centered in the hole and to compensate for some deflection of the center rib. Grommets space the material away from the support rod which enables the center of the support rod 4 to pass through the center of the hole 3. Centering the support rod in the hole allows the drape to be drawn across a greater distance without the pole binding on the sides of the hole. So less fabric is required to cover the window.

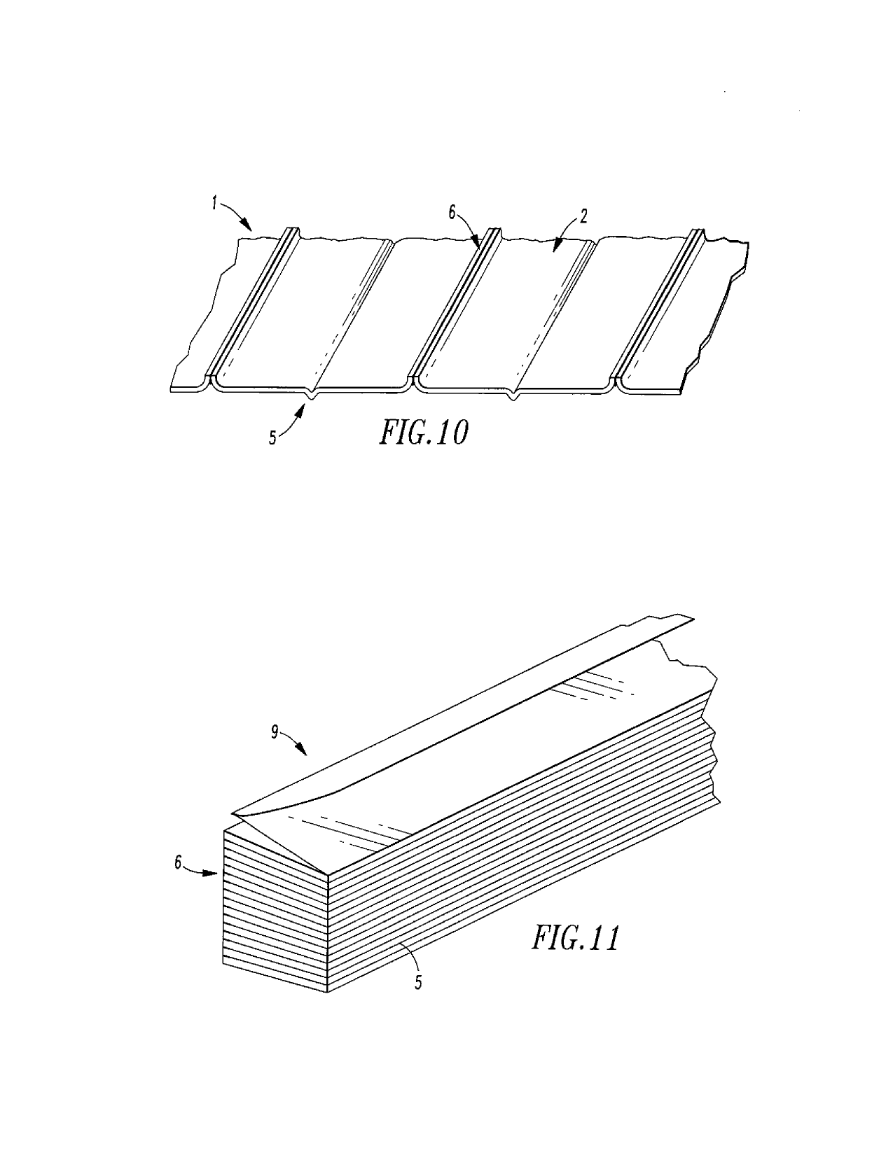

Referring to FIGS. 10 and 11 the drape 1 is made from a series of folded fabric, film or paper strips 2 which are attached together edge to edge to form a tab 6. This construction makes a permanent line at the tabs and slight curvature in the fabric when deployed that is further complimented by the opposed sharp creases or pleats in the fabric. This gives depth and character to the drape. The edges of adjacent segments preferably are bonded with an adhesive, such as polyester or polyurethane, or ultrasonically welded. One could sew the edges together. However, welding and bonding with an adhesive are much more precise and make a thinner stack. Bonds can adsorb into the fabric, whereas stitching adds at least two thread thicknesses to each tab, about 15 thousandths of an inch. When the edges are bonded together, they form a tab 6. The tab may be between 3/32 and ⅝ inch (0.24 to 1.56 cm) in width. I prefer that the tabs have a width equal or less than five eighths of an inch (1.56 cm). This tab can be made or trimmed down to be a micro tab of just less than one eighth of an inch (0.31 cm) in width.

Each of the segments is pleated equidistant between the edges. Consequently, pleats 5 are parallel to the tabs 6. Segments of about 7 to 12 inches (17.8 to 30.5 cm) are the recommended sizes in width. The segments are bonded together and folded along the pleats and tabs to form a symmetric stack 9, shown in FIG. 11. I prefer to create a stack 12 feet (3.65 m) in length because the lengths of most drapes (3 feet, 4 feet and 6 feet) are factors of 12 feet. The longer the starting length the more opportunity there is for optimizing yield and reducing waste. Window combinations rarely require lengths bigger than 12 feet and 12 feet is much larger than most materials available today. The stack can be almost any size that is convenient to handle. The size of the stack will correspond to the width of the drape. In the drape the width is counted in pleats and the length is the length of the stack.

When the fabricator receives an order for a drape he trims the required amount of material for the drape from the stack. Preferably the stack of pleated material has been made from strips bonded together as described above. Consequently, the tabs in the panel of pleated material will be along one edge of the stack and the pleats will be along the opposite edge of the stack. The fabricator or the manufacturer of the drape may trim the tabs so that they have a narrower width. The stack of window covering material will have a length that corresponds to the length of the drape and enough pleats to open the width of the open drape. Aesthetically I prefer a fullness of about 200% which means the width of each strip minus the tab and side hems equals twice the width of the open drape. The fabricator merely cuts the stack across its length. The fabricator must calculate the number of pleats needed and cut the material to the desired width. Fabric can be cut on relatively narrow tables compared to regular work room tables since the width of the drapery is simply counted out in pleats and the length can be cut all at once with a shear that is just wider than the width of the stack. Either the length or the width can be cut first or the material can be notched with a rough cut and then the cut out piece can be precisely sized (recut).

A fabricator should see that a significant advantage of this drapery is the substantial cost savings in manufacture and shipment of the product. The precision of the drape and the very small stack make shipping and installing much easier for the average person. Drapes take a specialized installer to get them “dressed out”. However, no specialized installer is required for the drape disclosed here because the pleats are already perfect and in the proper place. There will be significant savings in shipping and handling because the fabricator is working with boxes and stacks of material rather than rolls of material. The fabric segments which form the stack of the drapery material can be purchased in rolls having a width equal or larger to the width of the strips. A manufacturer of pleated layers will ship stacks of fabric with different dimensions in boxes that are easily handled and stored on ordinary shelving and require very simple equipment for sizing. The fabric stacks are easy to store and ship and take much less room than rolls of fabric. The manufacturer can have specialized equipment for handling rolls and can take rolls of fabric of almost any size, cut the fabric into narrow widths, then remove flaws and then convert the fabric into very wide 12 foot (3.65 m) layers. Common widths of many woven goods are 36″, 45″, 54″, 60″, 72″ and 96″ (which is much less common). The precision and permanent crease of the drape make it possible to use a variety of materials/fabrics that would not work well for ordinary drapes. Supply of fabric more competitive in narrower widths. Because the width of the drape to be fabricated is determined by the height of the stack rather than the width of the fabric on a roll, there is no limit to the transverse length of the drape which can be made other than the height of the stack. Should a flaw or broken thread appear in the fabric as it is being taken off the roll to be made into the stack, that portion of the material can be cut out and discarded. The waste will be much less than if a comparable shade had been made from a roll fabric having the same width as the shade. An additional advantage of using thermoplastic adhesive to make the tab is that these bonds can be heated and peeled apart and then reheated and sealed back together especially since the weight of the drape is not held by this bond. This allows the fabricator to cut out flaws and damage or change the shape of a stack in inventory. For example if he had a stack 12 feet (3.65 m) long and 30 pleats he could cut it in half and bond the two halves to make a stack of 60 pleats by 6 feet (1.83 m) long.

When the drapery is hung from a support rod the top of the drapery must be held at the center of gravity of the drape. That center of gravity typically will be along a centerline through the drape. If the drapery is not held at its center of gravity, the drape will sag toward the front or toward the rear and an unsightly wrinkle may appear across the top of the drape.

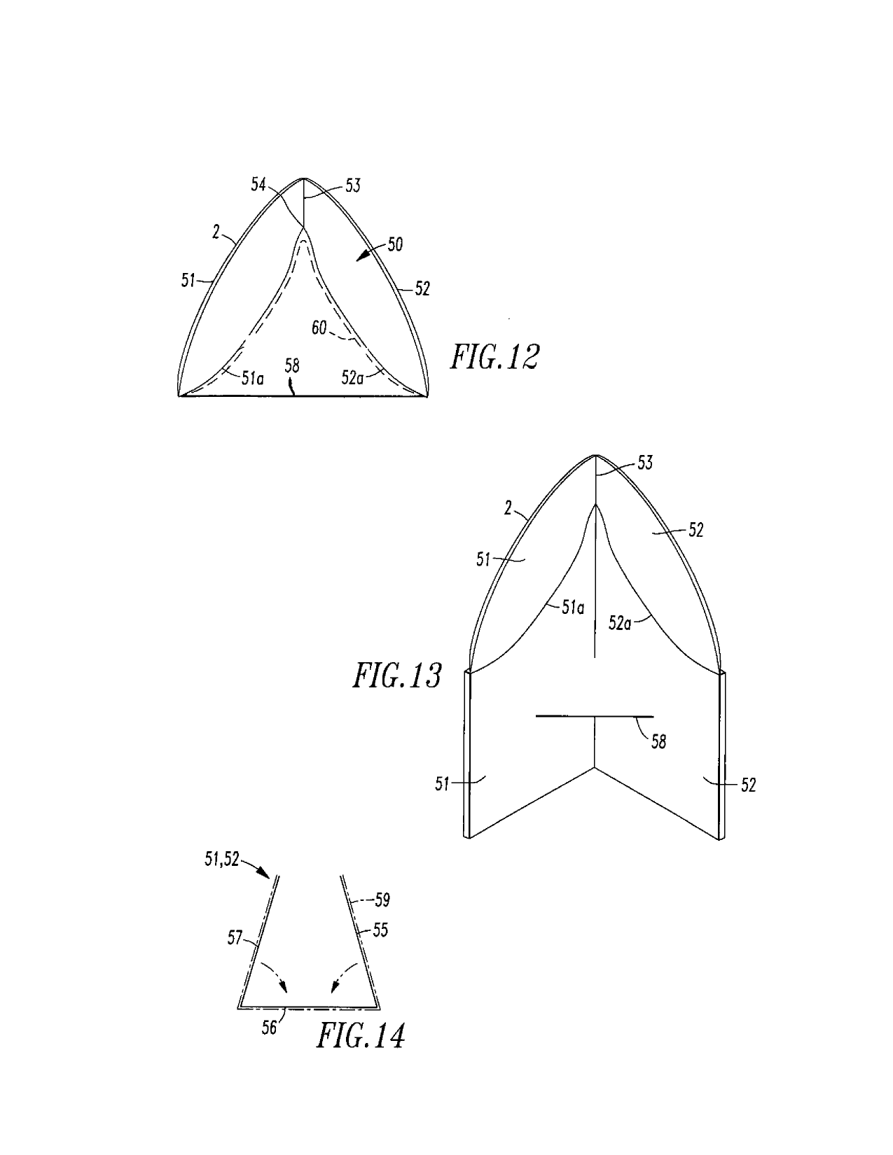

Referring to FIG. 12 a second present preferred embodiment has two outer limbs 2, 60 consisting of the drape fabric and an optional liner 60 which are made from two tabbed layers and two inner limbs 51 and 51a, 52 and 52a, which are portions of the header. The two layers 2 and 60 are interleaved then a header 40 is placed between them. This is stacked, clamped, and put in an oven at least as deep as the header, typically 4 to 6 inches (10.2 to 15.2 cm). The tab bonds may even melt in the oven, but they just rebond when cooled. The insert bonds side 56 to the drape. Side 55 is bonded to the liner and determines the length of the septum. Side 57 bonds to side 55 and makes it twice as strong. The liner 60 can be the length of the drape minus one fourth inch (0.6 cm) or it can be the same length as the vertical dimension of the header 4 to 6 inches (10.2 to 15.2 cm). In the first case the drape has a full length header 50 is shown in FIG. 12. This header has two sides 51 and 52 and a septum 53. The front edges of the sides and the septum are joined together at joint 54. The opposite edge of the septum is attached to the pleat 5 and the opposite edges of the sides are attached to the tabs 6 as shown in FIG. 12. I prefer that the sides each be made from a length of crinoline, cardboard as other stiff material. The side has a right segment 55 a center segment 56 and a left segment 57. The right segment 55 and the left segment 57 are folded over the center segment 56 as indicated by the arrows in FIG. 14. Those segments are the bonded together as shown in FIGS. 12 and 13. In use the center segment 56 and the joined right segment 55 and left segment 57 forming opposed arcs as shown in FIG. 12. Holes are provided in the strip and the sides 51 and 52 of the header through which the support rod 4 may pass. The holes are at the center of gravity of the drape to prevent sagging. If desired the sides could be sized so that the sides ride on top of the support rod. Finally, a spacer 58 is attached between the free ends of the sides 51, 52. The spacer may be a cord 58, a thin strip of material or a wide strip of material such as is used in the header shown in FIGS. 6 and 7. If grommets or partial grommets are used the spacer could be a cord attached to the grommets.

When headers are used one could attach a carrier to the header, eliminating the need to provide holes through the drape for a support rod. A pendant similar to pendant 18 in FIG. 2 could be attached to each side of the header and be connected to a carrier. Alternatively, the pendant, or at least the head of the pendant, could be moveably attached to the header where the center rib is at the center of gravity of the drape. The center of gravity moves as the drape opens and closes. The pendant can be attached to any of the sides of the header shown in FIG. 12 at the center of gravity.

By using strips of material I am able to create sharp creases that will all be parallel to one another in the drape. This cannot be consistently done using prior art ironing or pleating techniques on a single sheet of drapery material. Therefore, the present invention provides a drape having an appearance which has not been seen before.

While I have shown and described certain present preferred embodiments of my drape and method for making this drape, my invention is not limited thereto but may be variously embodied within the scope of the following claims.

I claim:

1. A drape comprising a panel of material having a length, a width, a top edge, a front and a back, the panel comprised of having a series of strips of material each strip have a pair of lengthwise, substantially parallel sides, the strips arranged side by side, adjacent strips being attached together in a manner so that adjacent lengthwise sides form a tab, each strip having a sharp lengthwise pleat substantially parallel to and between the substantially parallel sides of the strip such that the panel has a series of sharp pleats projecting outward on the front of the panel and a series of tabs projecting outward from the back of the panel.

2. The drape of claim 1 wherein the tabs have a width of between 3/32 and ⅝ inch.

3. The drape of claim 1 also comprised of a plurality of headers attached to the top edge of the panel.

4. The drape of claim 4 wherein each header is comprised of:
a center rib;
two sides, each side having a front edge and a rear edge, the sides being connected together and to the center rib along their front edges; and
a spacer comprised of two segments, each segment extending from the center rib to the rear edge of one of the sides, each segment having a fold such that the header can be collapsed from an open position to a closed position.

5. The drape of claim 1 also comprised of a plurality of headers attached to the top edge of the panel, one header attached to each strip of material in the panel, each header comprised of:
two font sides, each front side having a front edge and a rear edge, the front sides being connected together along their front edges;
two back sides, each back side having a front edge and a rear edge the front edges being connected together and connected to the front edges of the front side, the rear edge of each back side being connected to a rear edge of a respective front side.

6. The drape of claim 5 wherein the front side and the back side of the header are each a strip of material folded to have a center section a left section and a right section, the left section and the right section being folded over the center section to overlap one another and the left section being attached to the right section, such that the left section and right section together may be pulled away from the center section to form opposing arcs.

7. The drape of claim 6 wherein in the each strip has a pair of aligned holes through which a drapery rod may pass, the holes being at a center of gravity of the drape.

8. The drape of claim 7 also comprising a grommet within at least one hole in each strip and bonded to the strip.

9. The drape of claim 7 also comprising a partial grommet within at least one hole in each strip and bonded to the strip the partial grommet extending from an eleven o'clock position to a one o'clock position relative to the hole.

10. The drape of claim 7 also comprising a partial grommet within each hole in each strip and bonded to the strip the partial grommet extending from a ten o'clock position to a position past a twelve o'clock position relative to the hole.

11. The drape of claim 1 also comprising a spacer positioned between at least one pair of adjacent strips.

12. The drape of claim 1 also comprised of a plurality of headers attached to the top edge of the panel, each header comprised of two sides, each side having a front edge and a rear edge, the sides being connected together along their front edges to form a joint and each rear edge connected to one of the tabs.

13. A method of making a panel of material for a drape comprising:
providing a plurality of strips of material, each strip having a pair of spaced apart, parallel, longitudinal edges;
folding each strip of material to create a longitudinal pleat in each segment,
attaching the plurality of strips together side-by-side in a manner to form a panel wherein adjacent strips are attached together along a respective longitudinal edge of each strip in a manner to form a tab along each attached pair of longitudinal edges such that the tabs and the pleats create an accordion fold pattern; and
folding the panel to create a stack of material.

14. The method of claim 13 wherein the panel has a top edges and further comprising attaching a plurality of headers to the top edge of the panel.

15. The method of claim 14 wherein each header is comprised of
a center rib;
two sides, each side having a front edge, the sides being connected together along their front edges;
a rear edge; and
a spacer comprised of two segments, each segment extending from the center rib to the rear edge of one of the sides, each segment having a fold such that the header can be collapsed from an open position to a closed position.

16. The method of claim 16 wherein each header is comprised of:
two font sides, each front side having a front edge and a rear edge, the front sides being connected together along their front edges;
two back sides, each back side having a front edge and a rear edge the front edges being connected together and connected to the front edges of the front side, the rear edge of each back side being connected to a rear edge of a respective front side.
